(19) United States
(12) Patent Application Publication
(10) Pub. No.: US 2016/0140717 A1
(43) Pub. Date: May 19, 2016

(54) DATA PROCESSING APPARATUS

(71) Applicant: KABUSHIKI KAISHA TOSHIBA, Tokyo (JP)

(72) Inventors: Hidetaka OHIRA, Kawasaki (JP); Yusuke TAZOE, Kawasaki (JP); Kaoru SUGITA, Tokyo (JP); Masahiro SEKINE, Tokyo (JP); Masashi NISHIYAMA, Kawasaki (JP)

(21) Appl. No.: 14/847,148

(22) Filed: Sep. 8, 2015

(30) Foreign Application Priority Data
Nov. 18, 2014 (JP) 2014-233467

(51) Int. Cl. G06T 7/00; G06K 9/00; H04N 5/232

(52) U.S. Cl. CPC G06T 7/0042; H04N 5/23229; G06K 9/00362; G06T 2207/10004; G06T 2207/30196

(57) ABSTRACT

According to one embodiment, a data processing apparatus is capable of sensing a body shape of a user. The data processing apparatus includes a support base placed on a floor, a semi-silvered mirror standing from a rear end of the support base and a sensor including a light-receiving element and placed at a predetermined depression angle with respect to a horizontal orientation of the light-receiving element. The sensor is located such that the light-receiving element is positioned behind a mirror surface of the semi-silvered mirror, and a center of the light-receiving element is positioned above a center of the semi-silvered mirror.

### CROSS-REFERENCE TO RELATED APPLICATIONS

This application is based upon and claims the benefit of priority from Japanese Patent Application No. 2014-233467, filed Nov. 18, 2014, the entire contents of which are incorporated herein by reference.

### FIELD

Embodiments described herein relate generally to a data processing apparatus.

### BACKGROUND

In recent years, a variety of functions are installed in one product. For instance, a cellular phone has various functions, such as a mail function and a camera function, in addition to a communication function.

In accordance with such a recent tendency to incorporate various functions in one product, there is a demand for also providing various functions to a bathroom vanity unit or a dressing table that are frequently used on a daily basis. For example, it is requested to provide it with a function for sensing so-called body-shape parameters, such as a chest measurement, a waist measurement and a hip measurement.

### BRIEF DESCRIPTION OF THE DRAWINGS

FIG. 1 is a perspective view showing an appearance example of a data processing apparatus according to an embodiment.

FIG. 2 is a view for explaining a case where a sensor is arranged at the center of the data processing apparatus.

FIG. 3 is a view for explaining a case where a semi-silvered mirror and a display unit that constitute the data processing apparatus are provided separately.

FIG. 4 is a view showing an example of an image displayed on the display unit incorporated in the data processing apparatus.

FIG. 5 is a view for explaining the dimensions of a general bathroom vanity unit.

FIG. 6 is a view for explaining the dimensions of a bathroom vanity unit to be referred to for designing the data processing apparatus of the embodiment.

FIG. 7 is a view for explaining a depression angle, a field angle and an angle that defines the image-pickup area of a sensor to be considered when designing the data processing apparatus of the embodiment.

FIG. 8 is a view for explaining preferable dimensions for the data processing apparatus of the embodiment.

FIG. 9 is another view for explaining preferable dimensions for the data processing apparatus of the embodiment.

FIG. 10 is a perspective view showing an appearance example of a data processing apparatus having a structure different from the above.

### DETAILED DESCRIPTION

An embodiment will be described with reference to the accompanying drawings.

In general, according to one embodiment, a data processing apparatus is capable of sensing a body shape of a user. The data processing apparatus includes a support base placed on a floor, a semi-silvered mirror standing from a rear end of the support base and a sensor including a light-receiving element and placed at a predetermined depression angle with respect to a horizontal orientation of the light-receiving element. The sensor is located such that the light-receiving element is positioned behind a mirror surface of the semi-silvered mirror, and a center of the light-receiving element is positioned above a center of the semi-silvered mirror.

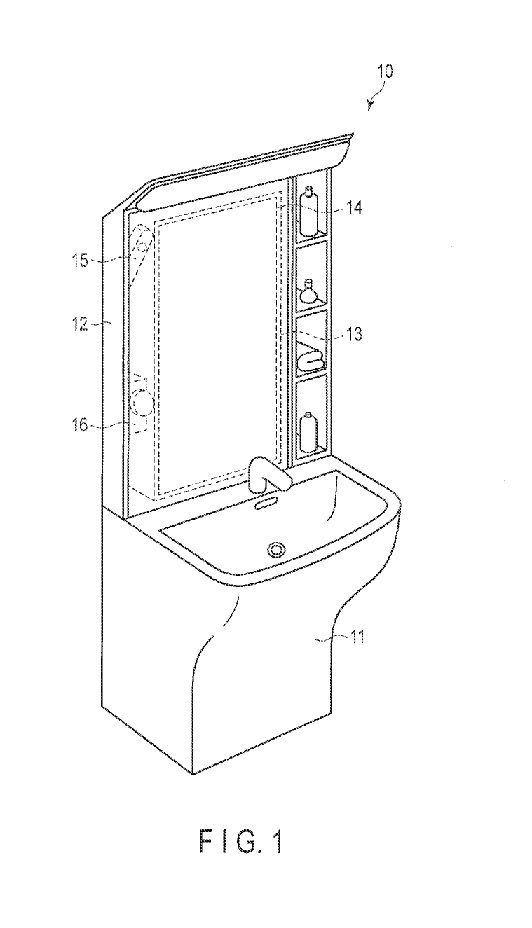

FIG. 1 is a perspective view showing an appearance example of a data processing apparatus according to the embodiment. The data processing apparatus shown in FIG. 1 is a measuring apparatus capable of sensing body-shape parameters of a photographic subject (user), and can be realized by, for example, a dressing table or a bathroom vanity unit. Hereinafter, it is assumed that the data processing apparatus is realized as a bathroom vanity unit.

The data processing apparatus has a function of acquiring body-shape parameters corresponding to not only the upper half of the body, but also the lower half of the body (i.e., the portion of the subject below the hips). In order to acquire body-shape parameters corresponding to the lower half of the body, it is necessary to locate a sensor, described later, so that the lower half of the body will fall within the image pickup area of the sensor even when the subject stands near the data processing apparatus.

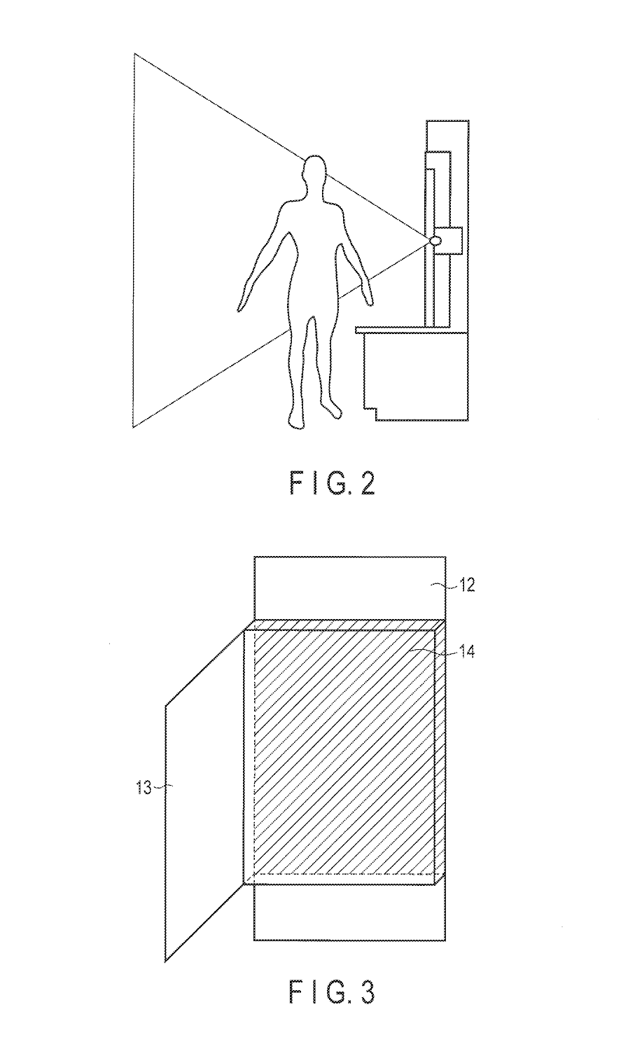

For instance, if the sensor is located at the center of the data processing apparatus as shown in FIG. 2, the lower half of the body does not fall within the image pickup area of the sensor, and hence body-shape parameters corresponding thereto cannot be acquired. To avoid this, it is possible to widen the view angle of the sensor to enable the lower half of the body to fall within the image pickup area of the sensor. However, even if the view angle of the sensor is widened, the support base included in the data processing apparatus falls within the image pickup area of the sensor, which hinders the lower half of the body from falling within the same.

In light of the above, the data processing apparatus of the embodiment has such a structure as shown in FIG. 1 in order to also acquire body-shape parameters corresponding to the lower half of the body of the subject. As shown in FIG. 1, the data processing apparatus 10 includes a support base 11, a back guard 12, a semi-silvered mirror 13, a display unit (display monitor) 14, a sensor 15, a camera 16, etc. In addition to the elements 11 to 16, the data processing apparatus 10 may further include an illumination lamp, a shelf, etc.

The support base 11 is installed on a floor. The support base 11 may be a so-called floor cabinet. If the support base 11 is a floor cabinet, it can be used as a storage space since it has a space therein. The floor cabinet may have an openable/closable door. The floor cabinet may further include one or more drawers. Further, since the data processing apparatus 10 is realized as a bathroom vanity unit, a drainpipe connected to a drain is accommodated in the space of the floor cabinet. A washbasin and a faucet are suitably provided at the upper surface of the support base 11. The support base 11 may have any known shape.

The back guard 12 is stood upright from the rear end of the support base 11 so that the length of the guard is perpendicular to the upper surface of the support base 11. The position from which the back guard 12 is stood upright is not limited to the rear end of the support base 11. It is sufficient if the support base 11 is stood upright from the upper surface of the support base 11. However, it is preferable that the back guard 12 is stood at a position as far as possible from the front surface of the support base 11 (i.e., a position close to the rear end of the support base 11), because if it is stood at a position on the upper surface of the support base 11 close to the front surface of the same, a washbasin or a faucet cannot be provided on the upper surface of the support base 11. A mirror unit including the semi-silvered mirror 13 and the display unit 14 formed integral as one body is incorporated in the back guard 12. However, the semi-silvered mirror 13 and the display unit 14 may be provided separately. In this case, as shown in, for example, FIG. 3, the display unit 14 is attached to the back guard 12, and the semi-silvered mirror 13 is attached thereto, with a predetermined space formed in front of the front surface of the display unit 14. As a result, the predetermined space formed in the front of the display unit 14 can be used as a storage space.

The semi-silvered mirror 13 has a front surface that functions as a mirror for reflecting light, and a rear surface (back) that functions to pass light therethrough. Namely, when a user looks into the front surface of the semi-silvered mirror 13, they can see their own figures reflected therefrom. Further, when looking into the rear surface of the semi-silvered mirror 13, they can see things (a scene, an object, etc.) located behind the semi-silvered mirror 13. Accordingly, when the user looks into the front surface of the semi-silvered mirror 13, with an image or a video image displayed on the display unit 14 located behind the semi-silvered mirror 13, they can see both their own figures and the image or video image displayed on the display unit 14.

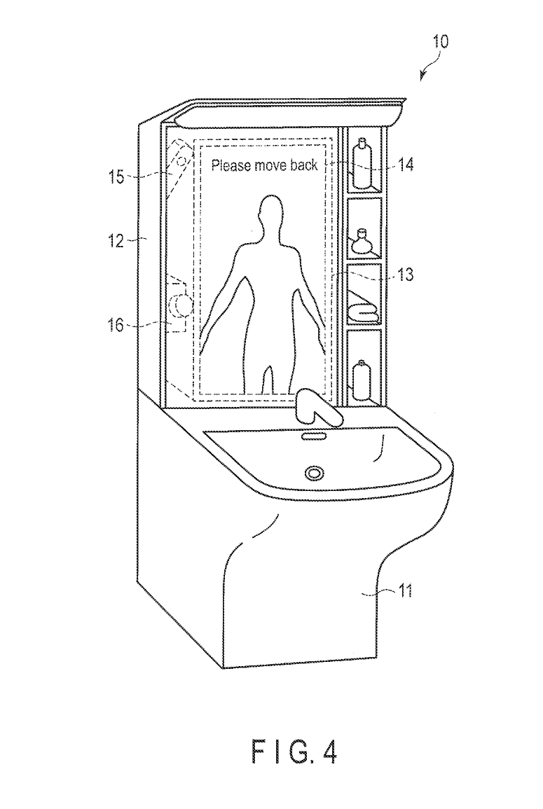

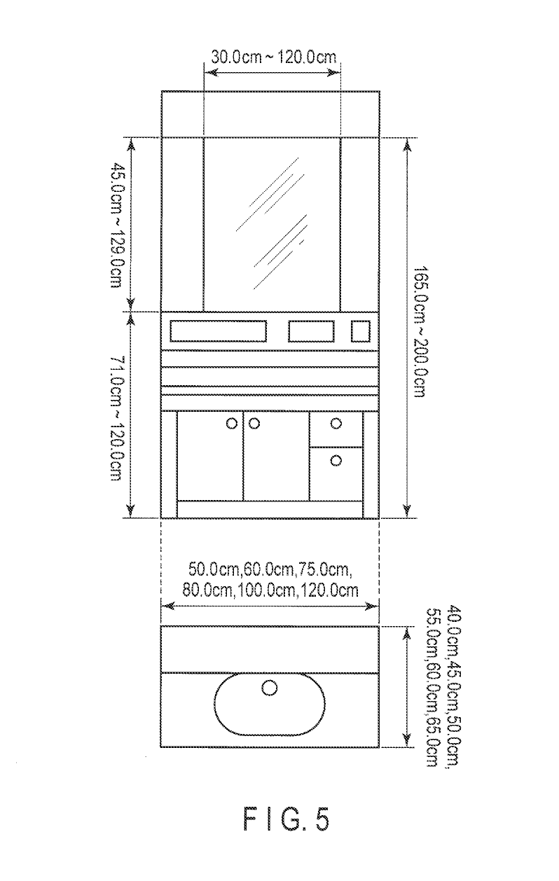

The display unit 14 displays the sensing result (namely, body-shape parameters obtained by the sensor 15) of the sensor 15, described later. Further, the display unit 14 may display a guidance message associated with the attitude or standing position of a photographic subject, in order that the sensor 15 can appropriately acquire body-shape parameters of the photographic subject, as is shown in, for example, FIG. 4. More specifically, the display unit 14 displays, as a silhouette, an ideal attitude or standing position of the photographic subject to be assumed when the sensor 15 acquires body-shape parameters of the photographic subject. At this time, if the standing position of the subject is too close to the data processing apparatus 10 (sensor 15), a message, for example, “please move back” may be also displayed. Alternatively, only the message may be displayed, without displaying the above-mentioned ideal attitude or standing position as a silhouette. Furthermore, a gauge, for example, capable of measuring the difference between the ideal attitude or standing position and an actual attitude or standing position of the subject may be displayed.

The sensor 15 is placed at a predetermined depression angle with respect to the horizontal orientation (of the light-receiving element) of the sensor 15. A depth sensor, described later, is built in the sensor 15. The sensor 15 is placed so that the light-receiving element of the depth sensor built in the sensor 15 will be located behind the mirror surface (front surface) of the semi-silvered mirror 13. Moreover, the sensor 15 is placed so that the center of the light-receiving element of the depth sensor built in the sensor 15 will be located above the center of the length of the semi-silvered mirror 13. That is, the sensor 15 is placed preferably above the display unit 14 with the above-mentioned depression angle.

The camera 16 is placed behind the mirror surface of the semi-silvered mirror 13. An image picked up by the camera 16 can be appropriately sent to and displayed on the display unit 14. For instance, the camera 16 is used when the user would like to focus a sensing result that is included in the sensing result of the sensor 15 and associated with a predetermined portion.

The function of the sensor 15 will now be described in detail.

Upon detecting a photographic subject, the sensor 15 sequentially picks up images of the photographic subject, and sequentially acquires depth images (which may be referred to as distance images) including the picked images. The acquired depth images are sent to an image-processing unit (not shown) described later. The depth images are images defined in distance from the sensor 15 pixel by pixel.

The sensor 15 may further acquire, for example, color images, in addition to the above-mentioned depth images. More specifically, upon detecting a photographic subject, the sensor 15 may sequentially pick up images of the photographic subject, thereby sequentially acquiring color images including the picked images. The color images are bitmap images, in which pixel values indicating the color, luminance, etc., of the subject are defined pixel by pixel. As mentioned above, when the sensor 15 is made to be also able to acquire color images, it further incorporates a known image-pickup device (camera) as well as the depth sensor.

Since the sensor 15 is thus made to be able to acquire color images, it can generate depth images from color images of a photographic subject, without utilizing a depth sensor, and utilizing a well-known method, such as stereo matching.

A detailed description will then be given of the above-described image-processing unit (not shown).

When the image processing unit acquires a depth image from the sensor 15, it sets a threshold for a depth-directional distance included in the three-dimensional positions of the pixels forming the depth image, thereby extracting a person area. For instance, assume that the position of the depth sensor incorporated in the sensor 15 is set as an origin, and that a z-axis positive direction corresponds to a vector extending along the optical axis of the camera and directed from the origin of the depth sensor to the photographic subject. In this case, pixels that are included in those of the depth image and have positional coordinates along the depth (z-axis) greater than a predetermined threshold are excluded. As a result, the image processing unit can acquire, from the depth sensor, an image consisting of pixels corresponding to the person area that exists in a range inside the above-mentioned threshold, i.e., the depth image of the photographic subject.

The image processing unit predicts body-shape parameters of the photographic subject from the above-mentioned depth image of the photographic subject. Specifically, the image processing unit applies three-dimensional model data of a human body to the depth image of the photographic subject. Subsequently, the image processing unit computes body-shape parameter values (such as chest, waist, hip, height, shoulder measurements) of the photographic subject, using the depth image and the three-dimensional model data applied to the photographic subject. The computed body-shape parameter values are displayed on the display unit 14.

A description will then be given of desirable dimensions (sizes) of the data processing apparatus 10.

When the data processing apparatus 10 is realized as a bathroom vanity unit, it is necessary to design the data processing apparatus 10 with dimensions as shown in FIG. 5 according to the Japanese Industrial Standards (JIS). Namely, the depth of a washbasin must be 40.0, 45.0, 50.0, 55.0, 60.0 or 65.0 cm. Similarly, the width of the washbasin must be 50.0, 60.0, 75.0, 80.0, 100.0, or 120.0 cm. Although in this case, a description is given of the depth and width of the washbasin as examples, the same can be said of the lengths of the other parts, and hence no detailed description will be given thereof.

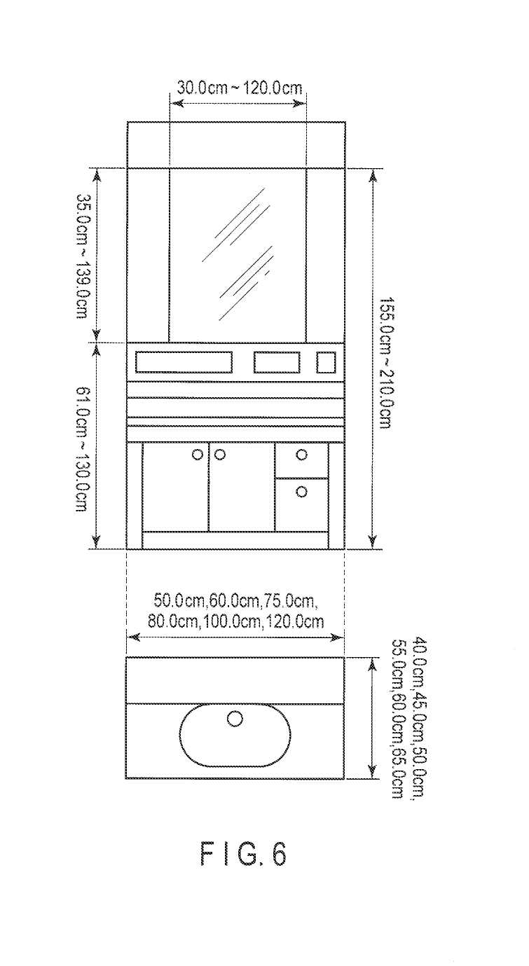

However, the Japanese Industrial Standards are standards for Japanese people. That is, the lengths of parts shown in FIG. 5 are values computed based on the average height of Japanese people, and are not values computed in consideration of people of countries other than Japan. For this reason, in the embodiment, a description will also be given of a case shown in FIG. 6 where the data processing apparatus 10 is designed for people other than Japanese to set the parts of the bathroom vanity unit to lengths different from those of FIG. 5 by ±10 cm.

When determining desirable dimensions of the data processing apparatus 10, it is necessary to consider keeping the support base 11 from falling within the image pickup area of the sensor 15 as a shielding object. Namely, it is necessary to consider excluding such a situation as described referring to FIG. 2. Conditions for the support base 11 as a shielding object to be kept from falling within the image pickup area of the sensor 15 will firstly be described.

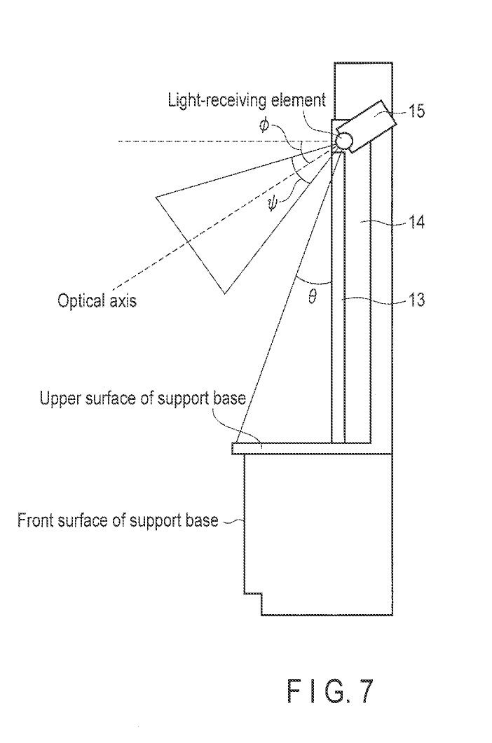

The conditions for the support base 11 to be kept from falling within the image pickup area of the sensor 15 lie in that the depression angle φ of the sensor 15 with respect to the horizontal orientation thereof, an angle ψ indicating the image pickup area of the sensor 15, and an angle θ defining the image pickup area of the sensor 15, which are shown in FIG. 7, satisfy the following mathematical expression (1):

$$\frac{ϕ}{2} + φ \leq \frac{π}{2} - θ \qquad ( 1 )$$

The angle θ defining the image pickup area of the sensor 15 can be computed based on the following equation (2):

θ=tan⁻¹(distance A/distance B) (2)

where distance A is the distance between the front surface of the support base and the rear end of the light-receiving element of the sensor, and distance B is the distance between the upper surface of the support base and the upper end of the light-receiving element of the sensor.

The most preferable conditions for acquiring (estimating) not only body-shape parameters corresponding to the upper half of the photographic subject, but also body-shape parameters corresponding to the lower half of the photographic subject, include a condition that the above mathematical expression (1) is satisfied, and a condition that the left-hand and right-hand sides of the mathematical expression (1) have as high values as possible and the mathematical expression (1) approaches an equation.

Firstly, in order to cause the left-hand and right-hand sides of the mathematical expression (1) to have as high values as possible, it is preferable that the angle θ should be as small as possible. In order to set the angle θ small, it is necessary to shorten the distance between the front surface of the support base 11 and the rear end of the light-receiving element of the sensor 15, or to lengthen the distance between the upper surface of the support base 11 and the upper end of the light-receiving element of the sensor 15. In order to reduce the angle θ, it is more preferable to lengthen the distance between the upper surface of the support base 11 and the upper end of the light-receiving element of the sensor 15, than to shorten the distance between the front surface of the support base 11 and the rear end of the light-receiving element of the sensor 15. This is because of variable ranges in length. More specifically, when shortening the distance between the front surface of the support base 11 and the rear end of the light-receiving element of the sensor 15, it is necessary to shorten the depth of the support base 11. However, the depth of the support base 11 should be changed within a range of about 40.0 cm to 65.0 cm in the case of FIG. 6. In contrast, when lengthening the distance between the upper surface of the support base 11 and the upper end of the light-receiving element of the sensor 15, it is necessary to increase the height of the semi-silvered mirror 13. According to FIG. 6, the height of the semi-silvered mirror 13 can be changed within a range of about 35.0 cm to 139.0 cm. Thus, the variable length range of the semi-silvered mirror is greater than the variable depth range of the support base 11. Therefore, to set the angle θ small, it is preferable to lengthen the distance between the upper surface of the support base 11 and the upper end of the light-receiving element of the sensor 15.

A description will now be given of a case where the view angle ψ is increased to make the above-mentioned mathematical expression (1) approach an equation. An increase in the view angle ψ means an increase in the image pickup area of the sensor 15. In this case, a greater amount of data can be obtained than when the image pickup area of the sensor 15 is narrow. In contrast, when the image pickup area of the sensor 15 is wide, a number of objects other than a photographic subject (user) may be included in the image pickup area. Namely, compared to the case where the image pickup area is narrow, the sensor 15 may not be able to obtain sufficient data needed to estimate body-shape parameters of the subject, although a greater amount of data can be obtained. This is because most of the greater amount of data is data associated with objects other than the photographic subject. To overcome this disadvantage, the sensor 15 may be changed from a sensor of general performance to a high-performance sensor. In this case, however, another problem that the manufacturing cost of the data processing apparatus 10 increases will arise. Therefore, it is not so desirable to increase the view angle ψ without careful consideration.

A description will then be given of a case where the depression angle φ is increased instead of the view angle ψ, in order to make the mathematical expression (1) approach an equation. By employing a large depression angle φ, the view angle ψ can be reduced. However, if the view angle ψ is too small, a portion of the photographic subject around the head cannot be made to fall within the image pickup area. From this, in order to set the data processing apparatus 10 to a preferable size, it can be understood necessary to set the view angle ψ not too small, with the depression angle φ maintained relatively large.

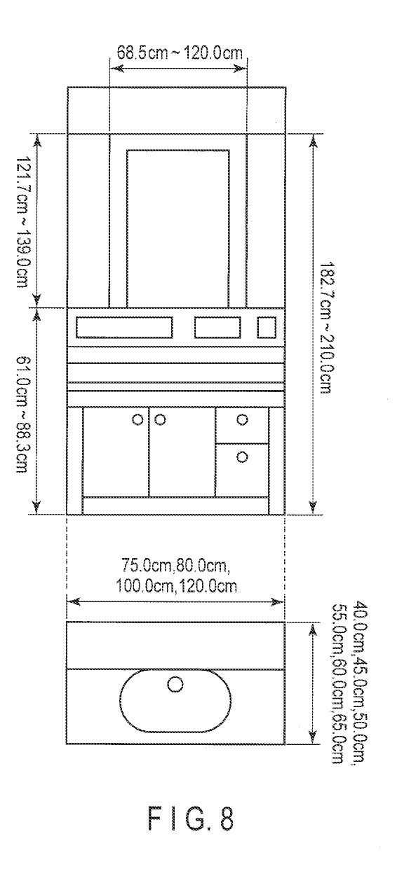

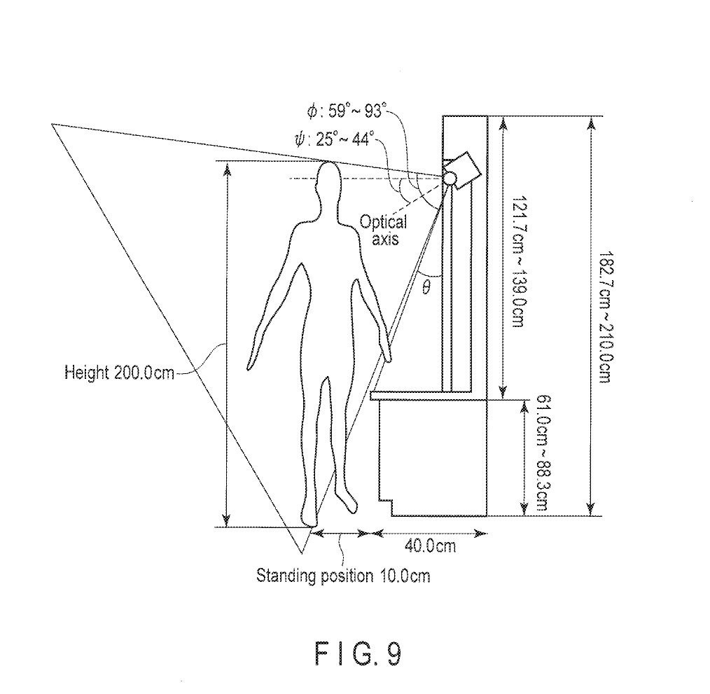

In view of the above, and on the assumption that the height of the photographic subject is 200 cm at maximum, and the distance of the standing position of the photographic subject from the front surface of the support base 11 is 10 cm at minimum, it is preferable to set the data processing apparatus 10 to the dimensions shown in FIG. 8. Specifically, the data processing apparatus 10 can have preferable dimensions when the view angle ψ falls within a range of 59 to 93°, the depression angle φ falls within a range of 25 to 44°, and the distance between the lower surface of the support base 11 (i.e., the floor) and the upper end of the sensor 15 is 182.7 cm to 210.0 cm. With these dimensions, the data processing apparatus 10 can also acquire not only the upper half but also the lower half of the body of the photographic subject, even if the height of the subject is 200 cm, as is shown in FIG. 9.

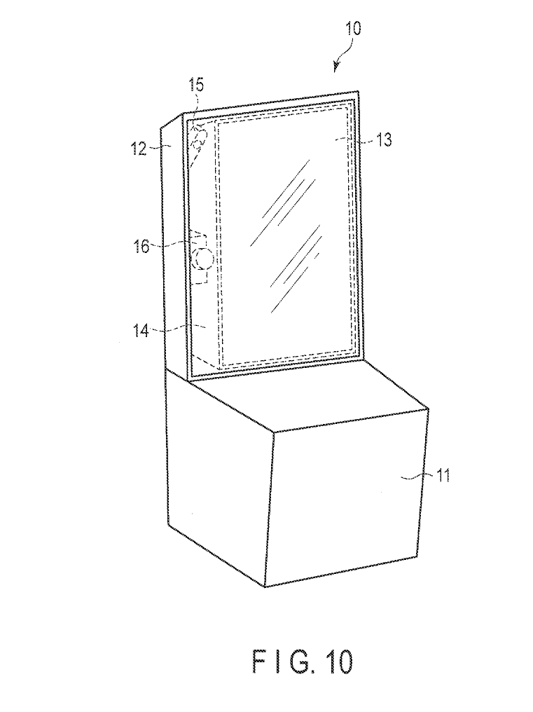

In addition, although in the embodiment, the data processing apparatus 10 is realized as a bathroom vanity unit, it may be realized as a dressing table as shown in, for example, FIG. 10.

Since in the above-described embodiment, the data processing apparatus 10 has the sensor 15 placed at a predetermined depression angle above the display unit 14 located behind the semi-silvered mirror 13, it can acquire body-shape parameters corresponding to not only the upper half but also the lower half of the body of a photographic subject. Namely, the embodiment can provide a data processing apparatus capable of sensing body-shape parameters.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data processing apparatus capable of sensing a body shape of a user, comprising:
a support base placed on a floor;
a semi-silvered mirror standing from a rear end of the support base; and
a sensor including a light-receiving element and placed at a predetermined depression angle with respect to a horizontal orientation of the light-receiving element,
wherein the sensor is located such that the light-receiving element is positioned behind a mirror surface of the semi-silvered mirror, and a center of the light-receiving element is positioned above a center of the semi-silvered mirror.

2. The data processing apparatus of claim 1, wherein the sensor is located to satisfy the following mathematical expression:
$$\frac{ϕ}{2} + φ \leq \frac{π}{2} - θ \qquad ( 1 )$$
where θ is an angle defining an image pickup area of the sensor, ψ is a view angle of the sensor, and φ is a depression angle of the sensor.

3. The data processing apparatus of claim 2, wherein the angle θ is given by
θ=tan⁻¹(distance A/distance B) (2)
where the distance A is a distance between a front surface of the support base and a rear end of the light-receiving element of the sensor, and the distance B is a distance between an upper surface of the support base and an upper end of the light-receiving element of the sensor.

4. The data processing apparatus of claim 1, further comprising a display monitor attached to a reverse surface of the semi-silvered mirror, the display monitor displaying a body-shape parameter indicating a body shape of the user sensed by the sensor.

5. The data processing apparatus of claim 4, wherein the display monitor is smaller than the semi-silvered mirror.

6. The data processing apparatus of claim 4, wherein the display monitor displays a guidance message used to enable the sensor to execute appropriate sensing.
